(19) United States
(12) Patent Application Publication
(10) Pub. No.: US 2025/0044621 A1
(43) Pub. Date: Feb. 6, 2025

(54) FERROELECTRIC HELICAL LIQUID CRYSTAL MATERIAL AND METHOD FOR REALIZING SECOND HARMONIC ENHANCEMENT THEREFOR

(71) Applicant: SOUTH CHINA UNIVERSITY OF TECHNOLOGY, Guangzhou (CN)

(72) Inventors: Satoshi AYA, Guangzhou (CN); Mingjun HUANG, Guangzhou (CN); Xiuhu ZHAO, Guangzhou (CN); Jinxing LI, Guangzhou (CN)

(73) Assignee: SOUTH CHINA UNIVERSITY OF TECHNOLOGY, Guangzhou (CN)

(21) Appl. No.: 18/704,933

(22) PCT Filed: Oct. 30, 2022
(86) PCT No.: PCT/CN2022/128471

§ 371 Date: Apr. 26, 2024

(30) Foreign Application Priority Data
Oct. 28, 2021 (CN) 202111267015.0

(51) Int. Cl. G02F 1/00; C09K 19/02; C09K 19/20; C09K 19/58; G02F 1/355; G02F 1/37

(52) U.S. Cl. CPC G02F 1/0045; C09K 19/0225; C09K 19/2007; C09K 19/586; G02F 1/3551; G02F 1/37; C09K 2019/2078

(57) ABSTRACT

The present invention discloses a ferroelectric helical liquid crystal material and a method for realizing second harmonic enhancement therefor. By means of the method, a ferroelectric helical liquid crystal with an ultrahigh polarity helical structure is obtained by doping chiral molecules with ferroelectric nematic phase liquid crystals, and a dielectric constant of the ferroelectric helical liquid crystal is 10⁴. This type of liquid crystal material has a superstrong nonlinear optical effect and can excite high-intensity second harmonic waves (for example, a nonlinear coefficient of the liquid crystal material is equivalent to that of a LiNbO₃ nonlinear (NLO) crystalline material). Based on adjustability of a periodical helical structure of the ferroelectric helical liquid crystal, a molecular pitch of the ferroelectric helical liquid crystal is tuned by means of a concentration of chiral molecules (i.e., a polarization period is regulated).

### TECHNICAL FIELD

The present invention belongs to the field of preparation and applications of nonlinear optical materials and discloses a kind of novel ultrahigh-polarity fluid material with a periodical helical structure which can meet a quasi-phase-matching condition, a manufacturing method for achieving second harmonic enhancement and an application thereof in terms of laser frequency doubling modulation.

### BACKGROUND

In 1961, P. A. Franken et al have reported a nonlinear frequency conversion phenomenon for the first time, which has initiated a new field of nonlinear optical research. For a nonlinear optical process, it is often described by means of a polarization response of light in a medium:

$$P = {ε}_{0} {χ}^{( 1 )} \cdot E + {ε}_{0} {χ}^{( 2 )} : EE + {ε}_{0} {χ}^{( 3 )} ⋮ EEE + … = {P}^{( 1 )} + {P}^{( 2 )} + {P}^{( 3 )} + …$$

In the formula, P and E are respectively an intensity of polarization and an electric vector. χ is a polarizability.

ε₀

is a vacuum permittivity,

$${P}^{{( 1 )}_{=}} {ε}_{0} {χ}^{( 1 )} \cdot E$$

is a linear intensity of polarization; various linear optical phenomena are described, the rest of items are nonlinear items which are used for describing nonlinear effects of light and substances. The most widely studied in the many nonlinear optical phenomena is a second-order nonlinear optical effect, particularly three-wave mixing, which is the primary method in current laser frequency conversion and expansion studies. In the three-wave mixing process, when the frequencies of two beams of incident light are equal, i.e., ω₁=ω₂=ω, frequency doubling light is emitted ω₃=ω₁+ω₂=2ω, i.e., an optical frequency doubling effect which is also called as a second harmonic phenomenon. Generally, the incident light is called fundamental frequency light, and the emitted light is called the frequency doubling light.

For an intensity generated by a second harmonic wave, if a walk-off effect is not considered, it can be simplified as the following relational expression:

$${I}_{2 ω} ∝ {L}^{2} \cdot {d}_{eff}^{2} \cdot {( \frac{sin ( Δ k \cdot L / 2 )}{Δ k \cdot L / 2} )}^{2} \cdot {I}_{ω}^{2}$$

In the formula, I_{2ω} and I_{ω} respectively represent intensities of the frequency doubling light and the fundamental frequency light, L is a thickness of a light beam passing through a sample, d_{eff} is an effective second-order nonlinear coefficient, and

$$Δ k = {k}_{2 ω} - 2 {k}_{ω} = \frac{4 π}{λ} ( {n}_{2 ω} - {n}_{ω} )$$

is a phase mismatch factor, where λ is a wavelength of the incident light. Thanks to a dispersion effect of the medium, generally n_{2ω}≠n_{ω}, i.e., Δk≠0, which is called as a phase mismatching condition. The intensity of the frequency doubling light varies periodically with increase of a length L of a crystal, and L_{c}=π/Δk is herein called a coherence length. In a process that L increases from 0 to L_{c}, the intensity of the frequency doubling light monotonically increases with increase of L, and energy is converted from the fundamental frequency light to the frequency doubling light; and in the process that L increases from L_{c} to 2 L_{c}, the intensity of the frequency doubling light monotonically decreases with increase of L, and energy is converted from the frequency doubling light to the fundamental frequency light on the contrary, reciprocating then all the time. Therefore, in the condition of phase mismatch, the nonlinear conversion efficiency is extremely low. As long as the phase matching condition Δk=0 is met, i.e., the propagation speeds of the fundamental frequency light and of the frequency doubling light in the medium are equal or the refractive indexes thereof are equal, the intensity of the frequency doubling light can increase continuously. In 1962, J. A. Armstrong, N. BLogembergen and et al have put forward a quasi-phase matching technology. Assuming that a laser amplitude of a pump is constant, a signal wavelength can be represented as a sum of domain numbers in the nonlinear optical medium, and generally, a change rate of the signal amplitude is:

$$\frac{\partial {A}_{2}}{\partial x} = {A}_{1}^{2} χ exp ( i Δ kx )$$

As to a nonlinear optical crystal which is periodically polarized, in the domain of each coherence length, a crystal axis of the crystal reverses at 180°, resulting in symbol change of the nonlinear polarizability χ. For a medium with n domains, χ can be represented as:

$$χ = {{χ}_{0} ( - 1 )}^{n}$$

when pump laser walks through n domains, the total amplitude of the generated laser is:

$${A}_{2} ( x ) = {A}_{1}^{2} {χ}_{0} \sum {( - 1 )}^{n} {\int }_{Λ n}^{Λ ( n + 1 )} {e}^{i Δ kx} \partial x$$

The generated second harmonic intensity can be represented as:

$${I}_{2} = {A}_{2} {A}_{{2}^{*}} = {A}_{1}^{4} {χ}_{0}^{2} {Λ}^{2} {sinc}^{2} ( m Δ k Λ / 2 ) ( \frac{1 - {( - 1 )}^{N} cos ( m Δ k Λ N )}{1 + cos ( m Δ k Λ )} )$$

$${I}_{2} = \frac{4 {A}_{1}^{4} {χ}_{0}^{2} {L}^{2}}{{m}^{2} {π}^{2}}$$

Compared with birefringent phase matching, quasi-phase-matching compensates for phase mismatching by means of periodically distribution of optical properties of the nonlinear medium. When the light is propagated through a coherence length L_{c} in the nonlinear medium, a phase compensation of π is introduced by manual modulation, so that energy is continuously converted from the fundamental frequency light to the frequency doubling light. The quasi-phase-matching technology has no strict limitations on a wave vector direction and a polarization direction of a coupled light wave of the nonlinear medium as long as an appropriate polarization periodical structure is introduced manually. The polarization period of the nonlinear optical crystal can be calculated according to a relationship between a Sellmeier equation and a wave vector, i.e., Λ=2mL_{c}=mλ/2(n_{ω}−n_{2ω}) (m is an odd number).

The key to achieve the quasi-phase-matching process is to tune the appropriate nonlinear medium with the periodical structure, and the nonlinear optical crystal with a reverse parallel domain structure is a major nonlinear medium applied to the quasi-phase-matching technology. The nonlinear optical crystal has spontaneous polarization, and the spontaneous polarization can be changed by an external electric field. At present, there have been many processing methods for preparing ferroelectric domain structures for quasi-phase-matching. The most frequently used is patterned electrode and high voltage electric field polarization methods, and methods such as a growth striation method in early stage, photoassisted polarization developed in recent years and all-optical polarization as well. These methods are tedious in preparation process and high in requirement on equipment, and are challenging to manufacture periodical polarized crystals with high quality and reliability as long as some crystal materials are used. Details and success rate of preparation depend, to a great extent, on materials (not only material types, but also defect concentration, chemometry, surface treatment and the like). Periodical polarization can only be applied to crystals with considerable limited thicknesses, and for different processes, many different polarization periods are needed. It is to be additionally noted that to precisely predict the needed polarization period needs precise refractive index (Sellmeier) data. Light with extra wavelengths can be generated in an associated high-order process, which may result in interference in various ways.

In 2017, Doctor Mandle and professor Goodby in York University have synthesized a wedge molecule with a large electric dipole. It has been found by studies that the molecule shows a common nematic phase at a high temperature, but represents a novel nematic phase structure with ferroelectric characteristics at a low temperature (lower than 133° C.), i.e., molecular arrangement is subjected to spontaneous polarization, and nematic phase molecular dipole moments become orderly in spatial distribution to form domains with specific orientations. In the same year, professor Kikuchi Hirotsugu in Kyushu University has also found a polar nematic phase liquid crystal with an extremely high dielectric constant. The material also shows characteristics such as ultrastrong second harmonic response. At present, basic studies on the novel nematic phase is still in the initial stage, but it is of very high application value due to its extremely strong dielectric characteristic and nonlinear optical characteristics.

By adding chiral molecules into ferroelectric nematic phase liquid crystals, the ferroelectric helical liquid crystal with the periodical helical structure can be obtained. Compared with the conventional nonlinear optical crystals, the ferroelectric helical liquid crystal has a periodical domain structure similar to the nonlinear optical crystal within an intact period (i.e., within one pitch), and spontaneous polarization of the ferroelectric helical liquid crystal is arranged along a long axis direction of molecules. When the liquid crystal molecules are helically arranged along the helical axis, polarization characteristics are remained when being twisted at every 180° (i.e., a half pitch). Thus, when the liquid crystal molecules are twisted at 360° (an intact pitch) along the helical axis, it is equivalent to a polarization period of the nonlinear optical crystal, with two periodical polarization domain structures in reverse directions. The polarizability of the ferroelectric helical liquid crystal can be represented by the polarizability similar to that of the nonlinear optical crystal:

$$χ = {χ}_{0} sin ( \frac{2 π}{pitch} x )$$

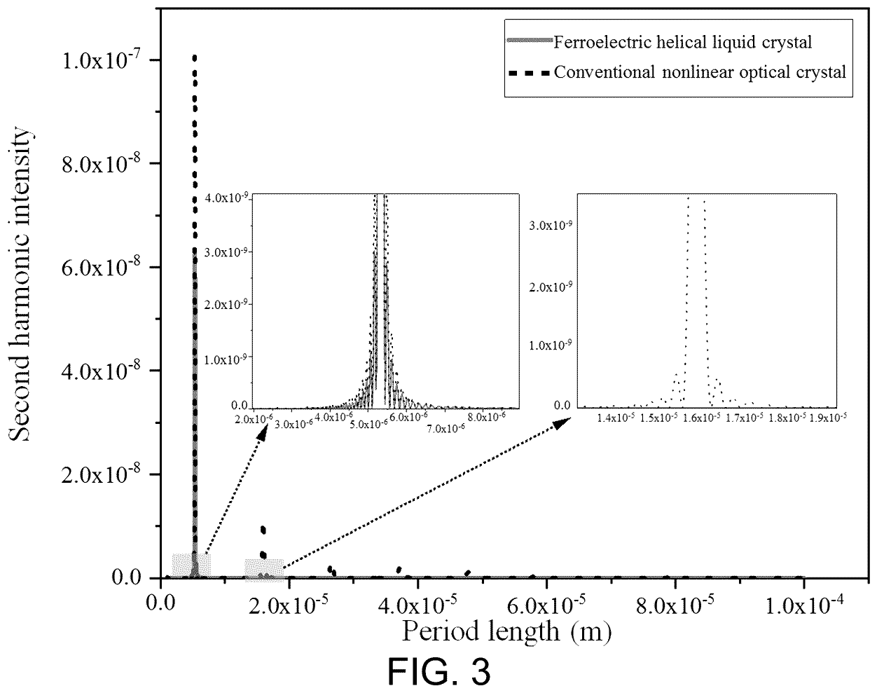

In a ferroelectric helical liquid crystal system, the polarization period can also be calculated according to the relationship between the Sellmeier equation and the wave vector. At the same time, it is also related to the periodical helical structure (pitch) of the ferroelectric helical liquid crystal, i.e., pitch=Λ=2mL_{c}=mλ/2(n_{2ω}−n_{ω}) (m is an odd number). Therefore, the quasi-phase-matching technology can be achieved by tuning the periodical helical structure of the ferroelectric helical liquid crystal. A simulated result with the second harmonic intensity and the coherence length L_{c} of the conventional nonlinear optical medium is shown in FIG. 3.

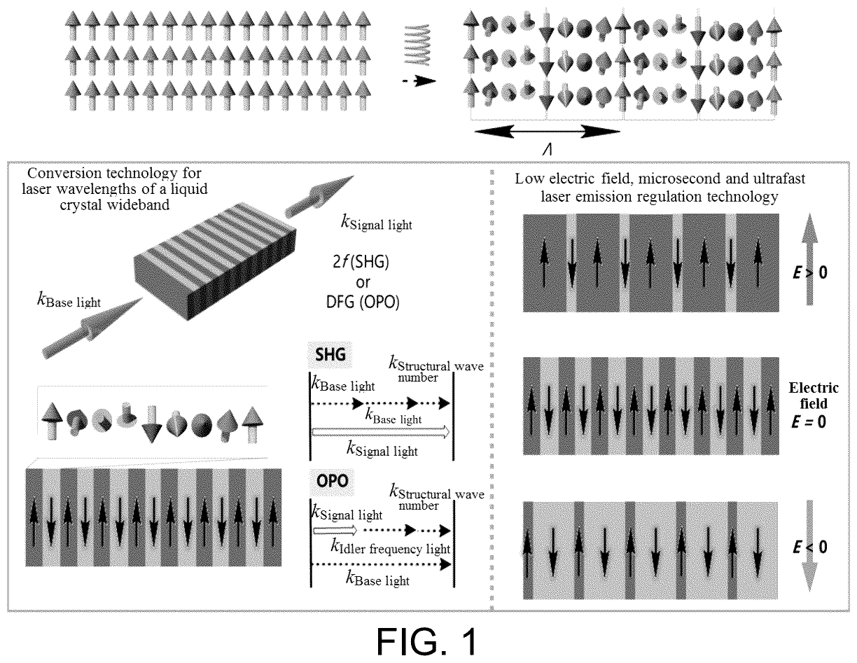

The ferroelectric helical liquid crystal responses to the electric field rapidly, the periodical polarization structure of the liquid crystal can be regulated by applying an in-plane electric field to the ferroelectric helical liquid crystal, and the regulation of the electric field is reversible. When a positive electric field (E>0) is applied to the ferroelectric helical liquid crystal, the polarization direction consistent to the direction of the positive electric field does not change, and polarization reverse to the direction of the positive electric field will rotate towards the direction where the electric field is applied to destroy the symmetry of the helical structure, so that the periodical polarization structure is changed; when the electric field is withdrawn, the changed polarization structure will be restored to the initial state (E=0); in a similar way, when the direction of the electric field is changed, i.e., a negative electric field (E<0) is applied to the ferroelectric helical liquid crystal, polarization consistent to the direction of the negative electric field does not change, and polarization reverse to the direction of the negative electric field will rotate towards the direction where the electric field is applied, so that the periodical polarization structure can be regulated. When the electric field is withdrawn, the changed polarization structure will be restored to the initial state (E=0) (see FIG. 1 for details). Moreover, compared with the conventional nonlinear optical liquid crystals, the liquid crystal has good mobility, is easy to be prepared into a device, and the periodical polarization structure of the ferroelectric helical liquid crystal is easily tuned. As the ferroelectric nematic phase liquid crystal is found, the ferroelectric helical liquid crystal becomes a potential nonlinear medium with the periodical polarization structure to meet the quasi-phase-matching condition, so as to achieve second harmonic enhancement, which has a wide application prospect in the field of laser frequency doubling.

### SUMMARY OF THE INVENTION

### Technical Problem

### Solution to Problem

### Technical Solutions

At present, achievement of second harmonic enhanced by means of the quasi-phase-matching technology is concentrated in the field of tuning nonlinear optical crystals with periodical structures. Most of these methods are tedious in preparation process and high in requirements on equipment. A ferroelectric helical liquid crystal material with a periodical helical structure is prepared by coupling ferroelectric nematic phase liquid crystals and chiral molecules. The ferroelectric helical liquid crystal material has an ultrastrong second harmonic response characteristic, and can activate photons itself. Moreover, the periodical helical structure of the ferroelectric helical liquid crystal material is convenient to be tuned and can be tuned to the polarization period needed by quasi-phase-matching, so as to achieve second harmonic enhancement, which is the first case in the application field of the quasi-phase-matching technology. Moreover, compared with the conventional quasi-phase-matching technology, the ferroelectric helical liquid crystal material has the characteristics of no complicated equipment, convenient and tunable period, easy manufacturing and the like, and has a wider application prospect in the field of optical frequency doubling.

The object of the present invention is achieved by the following measures.

A ferroelectric helical liquid crystal material, obtained by uniformly mixing chiral molecules with ferroelectric nematic phase liquid crystals at a certain mass ratio, wherein a mass fraction of the chiral molecules in a mixture is 0.4%-1.5%, and the ferroelectric helical liquid crystal material has macroscopical helical polarity based on having a conventional cholesteric phase periodical helical structure, and the macroscopical helical polarity is provided by the ferroelectric nematic phase liquid crystals; and the periodical helical structure is provided by a cholesteric phase liquid crystal formed by coupling the chiral molecules and the ferroelectric nematic phase liquid crystals.

Further, refractive indexes of the ferroelectric nematic phase liquid crystal at frequency doubling light and at fundamental frequency light are n_{2ω} and n_{ω}, and a polarization period of the ferroelectric helical liquid crystal material is calculated according to an equation pitch=Λ=2mL_{c}=mλ/2(n_{n2ω}−n_{ω}), m being an odd number.

Further, the pitch of the ferroelectric helical liquid crystal material is realized by changing the mass ratio of the chiral molecules to the ferroelectric nematic phase liquid crystals (the chiral molecules with the mass fraction of 0.4%-1.5%).

Further, the ferroelectric helical liquid crystal material has a high dielectric constant and an ultrastrong second harmonic response characteristic at 128-65° C.

Further, the high dielectric constant ε is ˜104.

Further, the second harmonic response characteristic of the ferroelectric helical liquid crystal material is 3-10 times that of a quartz crystal.

Further, when the pitch of the ferroelectric helical liquid crystal material is tuned to the polarization period needed by quasi-phase-matching, second harmonic enhancement can be realized.

Further, the ferroelectric helical liquid crystal material has a tunable helical period with different concentrations of a chiral dopant, and the tunable helical period can be tuned to a polarization period meeting a quasi-phase-matching condition.

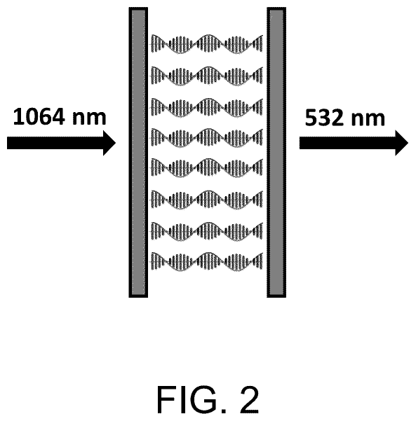

Further, a certain number (0-100, but not limited thereto) of periodical helical structures of the ferroelectric helical liquid crystal material can be uniformly distributed in liquid crystal boxes with different thicknesses, with reference to arrangement of the liquid crystal molecules in the schematic diagram of wavelength conversion of the ferroelectric helical liquid crystal in FIG. 2 for details.

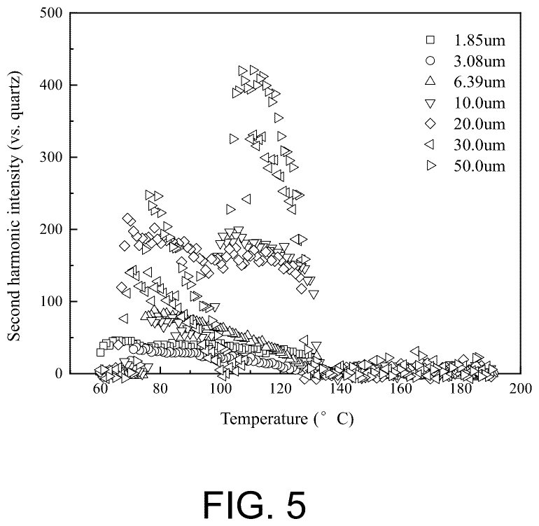

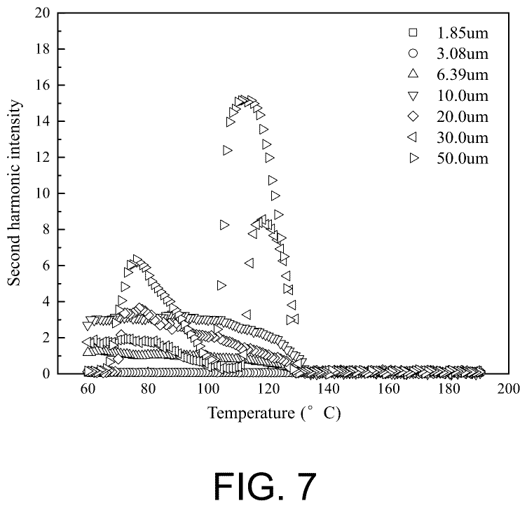

Further, when the ferroelectric helical liquid crystal material reaches the polarization period of a quasi-phase-matching technology, second harmonic intensity of the ferroelectric helical liquid crystal material increases with an increase of the thickness (see FIGS. 5 and 7 for details), respectively being temperature-varying changes of second harmonic generation (SHG) signals of 1.1% R811/RM734 samples with different thicknesses at a focal point and parallel light.

A manufacturing method for realizing second harmonic enhancement by means of the quasi-phase-matching technology:

Two glass substrates in parallel frictional alignment with polyimide are manufactured into liquid crystal boxes with different thicknesses, and ferroelectric helical liquid crystals are poured into the liquid crystal boxes by means of the capillary action. Annealing treatment is performed at 370-440 K for half an hour, so that a cholesteric phase forms a stable planar texture.

Further, the pitch of the ferroelectric helical liquid crystal can be adjusted by a concentration ratio of the chiral molecules. When the concentration of the chiral molecules is within a certain range, the pitch of the ferroelectric helical liquid crystal also changes, and SHG enhancement can be achieved by adjusting the pitch to the polarization period of quasi-phase-matching.

### BENEFICIAL EFFECTS OF THE INVENTION

### Beneficial Effects

Compared with the prior art, the present invention has the advantages and effects that:

The ferroelectric helical liquid crystal material provided by the present invention has the ultrastrong second harmonic response, and its nonlinear optical characteristic can be on a pair with that of a quartz phase in the crystal, which is quite rare in a fluidic soft material. By changing the doping concentration of the chiral molecules, the molecular pitch can be adjusted to meet the quasi-phase-matching condition, so as to achieve second harmonic enhancement. Compared with polar nematic phases without doping the chiral molecules, its second harmonic intensity is improved by over 4 times. Compared with the existing nonlinear optical crystal with the appropriate tuned periodical structure, the material is simple in preparation process, convenient to adjust the pitch, low in requirement on equipment and low in temperature sensitivity, and can work in a wider temperature range. Compared with common nonlinear optical crystals, the ferroelectric helical liquid crystal is capable to adjust the molecular pitch conveniently by means of the doping concentration of the chiral molecules, has flexible, easy-machining and film-forming characteristics, is capable to achieve working scenarios where many crystals cannot be applied, further has a cost advantage, and is capable to be better applied to the fields such as laser frequency doubling modulation.

### BRIEF DESCRIPTION OF DRAWINGS

### Description of Drawings

FIG. 1 is a schematic diagram of second harmonic enhancement;

FIG. 2 is a schematic diagram of wavelength conversion of a ferroelectric helical liquid crystal, where incident light with a wavelength of 22 is converted into a light wave with a wavelength of 2 by means of a nonlinear optical effect of the ferroelectric helical liquid crystal;

FIG. 3 is a relational diagram between second harmonic waves and period lengths of a conventional nonlinear optical medium and the ferroelectric helical liquid crystal (represented as n times of a coherence length L_{c});

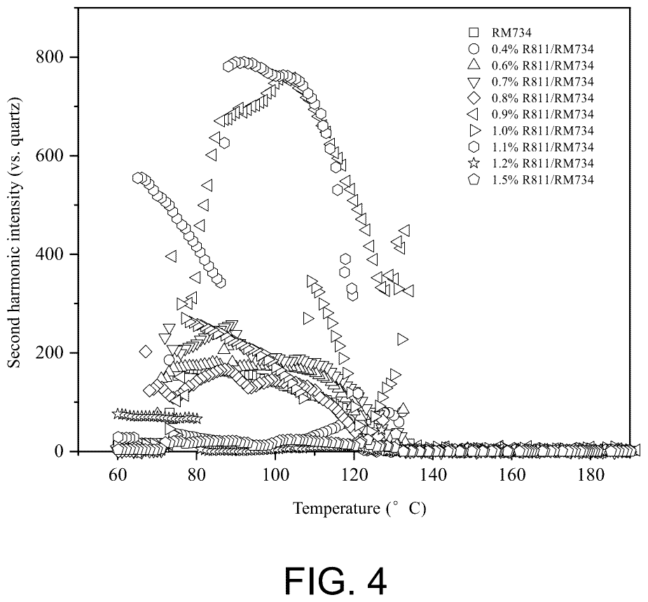

FIG. 4 show SHG signal values of a mixture of the chiral molecules with different concentrations and the ferroelectric nematic phase liquid crystals (y axis is a ratio between SHG signal values of the mixture and the intensity of a quartz activated second harmonic wave);

FIG. 5 shows temperature-varying changes of SHG signals of 1.1% R811/RM734 samples with different thicknesses at a focal point (y axis is the ratio between SHG signal values of the 1.1% R811/RM734 samples and the intensity of a quartz activated second harmonic wave);

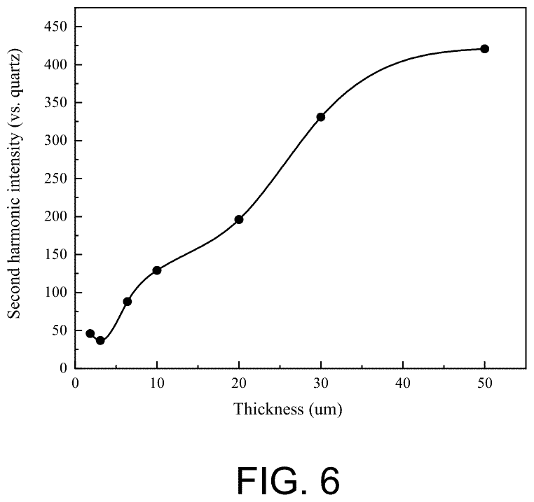

FIG. 6 shows the maximum value of the SHG signals of 1.1% R811/RM734 samples with different thicknesses at the focal point:

FIG. 7 shows temperature-varying changes of SHG signals of 1.1% R811/RM734 samples with different thicknesses at a parallel light path (the quartz signal is nearly 0 at the parallel light path, and the samples still have strong signals);

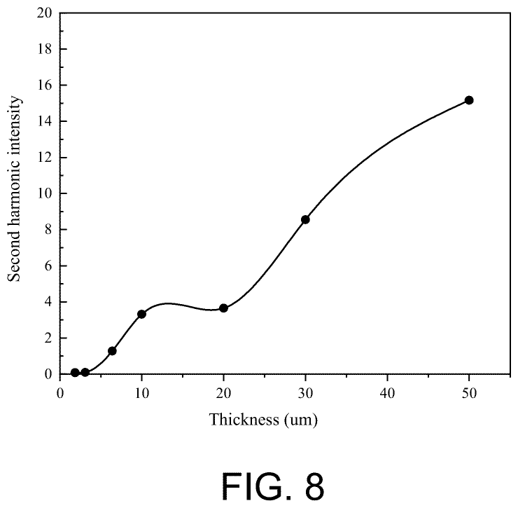

FIG. 8 shows the maximum value of the SHG signals of 1.1% R811/RM734 samples with different thicknesses at the parallel light path.

### INVENTION EMBODIMENTS

### Embodiments of the Invention

The present invention is further described in detail below in combination with specific embodiments, which does not limit the scope of the present invention.

### Embodiment 1

A method for preparing a ferroelectric helical liquid crystal with a doping concentration of chiral molecules being 1.1% is as follows:

0.05% by mass of chiral molecules and 5% by mass of a ferroelectric nematic phase solution were respectively prepared with trichloromethane as a solvent; then a mixture solution was prepared according to a mass ratio of the chiral molecules and ferroelectric nematic phase liquid crystals being 1.1/98.9; and the mixture solution was vacuum-dried to obtain a uniform mixture marked as 1.1% R811/RM734.

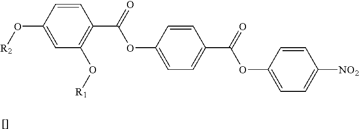

is the ferroelectric nematic phase liquid crystals, and R1 and R2 are methyl.

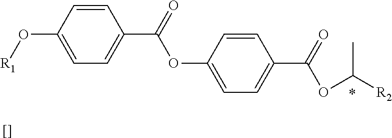

is the chiral molecules, and R1 and R2 are —C₆H₁₃.

### Embodiment 2

A method for preparing a polar cholesteric phase liquid crystal with a doping concentration of chiral molecules being 1.0% is as follows:
0.05% by mass of chiral molecules and 5% by mass of a ferroelectric nematic phase solution were respectively prepared with trichloromethane as a solvent; then a mixture solution was prepared according to a mass ratio of the chiral molecules and polar nematic phase liquid crystals being 1.0/99; and the mixture solution was vacuum-dried to obtain a uniform mixture marked as 1.0% R811/RM734.

### Embodiment 3

A method for preparing a polar cholesteric phase liquid crystal with a doping concentration of chiral molecules being 0.9% is as follows:
0.05% by mass of chiral molecules and 5% by mass of a ferroelectric nematic phase solution were respectively prepared with trichloromethane as a solvent; then a mixture solution was prepared according to a mass ratio of the chiral molecules and polar nematic phase liquid crystals being 0.9/99.1; and the mixture was vacuum-dried to obtain a uniform mixture marked as 0.9% R811/RM734.

### Embodiment 4

A second harmonic enhancement method is achieved as follows:

Two glass substrates (1 cm2) coated with polyimide films were prepared into liquid crystal boxes after being subjected to frictional orientation by velvet cloth, where thicknesses of the liquid crystal boxes were conveniently adjusted. The prepared ferroelectric helical liquid crystal was heated to a liquid phase, the liquid crystal would enter into the liquid crystal boxes under the capillary action, and its structure was shown in FIG. 2. Annealing treatment was performed at 400 K for half an hour, so that a cholesteric phase formed a stable planar texture.

If pulse laser at 1064 nm was used as a light source, thanks to the nonlinear optical characteristics of the polar cholesteric phase, a second harmonic wave at 532 nm would be generated. Correspondingly, the doping concentration of the chiral molecules was changed to 1.1%, and the pitch was adjusted to meet the polarization period of the quasi-phase-matching technology, thereby achieving a second harmonic enhancement effect. Emitted second harmonic waves were detected with a photomultiplier detector, and were compared with response intensities of second harmonic waves of quartz under same conditions (shown in FIGS. 4-8). FIG. 4 show SHG signal values of a mixture of the chiral molecules with different concentrations and the ferroelectric nematic phase liquid crystals, and it can be seen that the SHG signal value is the maximum when the concentration of the chiral molecules is 1.1%; FIG. 5 shows temperature-varying changes of SHG signals of 1.1% R811/RM734 samples with different thicknesses at a focal point; FIG. 6 shows the maximum value of the SHG signals of 1.1% R811/RM734 samples with different thicknesses at the focal point, where the greater the thickness is, the more the polarization periods are, so the SHG signal values are greater; FIG. 7 shows temperature-varying changes of SHG signals of 1.1% R811/RM734 samples with different thicknesses at a parallel light path; FIG. 8 shows the maximum value of the SHG signals of 1.1% R811/RM734 samples with different thicknesses at the parallel light path, where the greater the maximum thickness value is, the more the polarization periods are, so the SHG signal value is greater.

The above embodiments are preferred implementation modes of the present invention. The implementation modes of the present invention are not limited by the embodiments. Those skilled in the art of the present invention can further make several simple deductions or substitutions without departing from the concept of the present invention, and they shall be regarded as belonging to the scope of protection of the present invention.

1. A ferroelectric helical liquid crystal material, characterized in that, the ferroelectric helical liquid crystal material is obtained by uniformly mixing chiral molecules with ferroelectric nematic phase liquid crystals at a certain mass ratio, a mass fraction of the chiral molecules in a mixture is 0.4%-1.5%, and the ferroelectric helical liquid crystal material has macroscopical helical polarity based on having a conventional cholesteric phase periodical helical structure, and the macroscopical helical polarity is provided by the ferroelectric nematic phase liquid crystals; and the periodical helical structure is provided by a cholesteric phase liquid crystal formed by coupling the chiral molecules and the ferroelectric nematic phase liquid crystals.

2. The ferroelectric helical liquid crystal material according to claim 1, characterized in that, refractive indexes of the ferroelectric nematic phase liquid crystal at frequency doubling light and at fundamental frequency light are n_{2ω} and n_{ω}, and a polarization period of the ferroelectric helical liquid crystal material is calculated according to an equation pitch=Λ=2mL_{c}=mλ/2(n_{2ω}−n_{ω}), m being an odd number.

3. The ferroelectric helical liquid crystal material according to claim 1, characterized in that, the pitch of the ferroelectric helical liquid crystal material is realized by changing the mass ratio of the chiral molecules to the ferroelectric nematic phase liquid crystals, with the chiral molecules with the mass fraction of 0.4%-1.5%.

4. The ferroelectric helical liquid crystal material according to claim 1, characterized in that, the ferroelectric helical liquid crystal material has a high dielectric constant and a ultrastrong second harmonic response characteristic at 128-65° C.

5. The ferroelectric helical liquid crystal material according to claim 4, characterized in that, the high dielectric constant ε is 10⁴.

6. The ferroelectric helical liquid crystal material according to claim 4, characterized in that, the second harmonic response characteristic of the ferroelectric helical liquid crystal material is 3-10 times that of a quartz crystal.

7. A method for realizing second harmonic enhancement for the ferroelectric helical liquid crystal material according to claim 1, characterized in that, when the pitch of the ferroelectric helical liquid crystal material is tuned to the polarization period needed by quasi-phase-matching, second harmonic enhancement is capable of being realized.

8. The method for realizing second harmonic enhancement for the ferroelectric helical liquid crystal material according to claim 7, characterized in that, the ferroelectric helical liquid crystal material has a tunable helical period with different concentrations of a chiral dopant, and the tunable helical period is capable of being tuned to a polarization period meeting a quasi-phase-matching condition.

9. The method for realizing second harmonic enhancement for the ferroelectric helical liquid crystal material according to claim 7, characterized in that, the ferroelectric helical liquid crystal material is of a periodical helical structure capable of being uniformly distributed in liquid crystal boxes with different thicknesses.

10. The method for realizing second harmonic enhancement for the ferroelectric helical liquid crystal material according to claim 7, characterized in that, when the ferroelectric helical liquid crystal material reaches the polarization period of a quasi-phase-matching technology, second harmonic intensity of the ferroelectric helical liquid crystal material increases with an increase of the thickness, respectively being temperature-varying changes of second harmonic generation (SHG) signals of 1.1% R811/RM734 samples with different thicknesses at a focal point and at parallel light.
